(19) United States
(12) Patent Application Publication
(10) Pub. No.: US 2007/0065551 A1
(43) Pub. Date: Mar. 22, 2007

(54) Post package pasteurization for meat products

(76) Inventor: William J. Alton, Pepperell, MA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/520,428

(22) Filed: Sep. 13, 2006

Related U.S. Application Data
(60) Provisional application No. 60/718,106, filed on Sep. 16, 2005.

(51) Int. Cl. A23L 3/16

(52) U.S. Cl. 426/521

(57) ABSTRACT

A technique for treating packaged solid meat products by applying microwave energy at an elevated operating frequency such as 2450 MHz. The microwave energy is provided at a relatively low power level, such as 1 kilowatt (kW) per pound per minute. This frequency is sufficiently high such that energy penetration depth is limited, and thus it only causes rapid heating of the outer surface of the product. The result is thus much like searing in which the meat product is only heated to a minimum depth. Any juices trapped in the package are also heated rapidly, and spread to fill irregularities in the surface of the product. Because the exterior surface of the meat is heated only to a minimum depth, the interior of the meat product retains its desired doneness, color and texture. Only minimal cooling efforts need to be taken afterwards.

### RELATED APPLICATION

This application claims the benefit of U.S. Provisional Application No. 60/718,106, filed Sep. 16, 2005. The entire teachings of the above application are incorporated herein by reference.

### BACKGROUND OF THE INVENTION

Meat products such as beef and poultry have long been known to be at risk for contamination by various bacteria. Indeed, several high publicized events have occurred in recent years in the United States involving sickness and death as a result of contamination by bacteria such as listeria monocytogenes in packaged turkey products. Several techniques, such as pasteurization, can reduce possible contamination that would otherwise occur. In these processes, a radiant heat oven or temperature controlled water baths are used to kill harmful pathogens by post package pasteurization.

Increasingly more stringent approaches are being adopted by commercial food processes to effectively eliminate the risk of contamination. Many of the problems that lead to contamination with microorganisms, such as pathogenic bacteria, viruses, and parasites can be reduced with effective employee training programs and hygienic practices. Other problems are more difficult to control such as contamination with listeria monocytogenes, a pathogen that is ubiquitous in the processing environment. That is, if a meat product is packaged after the cooking process, it may have been contaminated by the handling and packaging process. This has been recognized by the United States Food and Drug Administration (FDA) and other food safety regulators such as the United States Department of Agriculture (USDA) Food Safety and Inspection Service (FSIS).

Post packaging heat treatments also referred to as post package pasteurization, has long been used for whole meat muscle products that must unavoidably be handled after their initial cooking. These treatments generally involve heating the surface of the packaged meat product to about 160° to 180°.

Such procedures may use procedures similar to heating techniques to cook the meat, such as with hot air or with steam. As described in U.S. Pat. No. 5,281,428 issued to Morgan. Similar techniques have been employed using infrared energy to heat the packaged meat.

Unfortunately, the known procedures for post package pasteurization invariably further cook the packaged meat product, but one often does not wish to cook certain products any further. For example, packaged beef products should have a desirable color and texture on both the outside and inside. Poultry products such as turkey or chicken can become dry and less palatable after additional cooking.

The problem with exterior heating such as hot air, water or steam is that they rely on conducting heat energy through the plastic wrapping into the meat surface, as well as conduction to heat sufficiently deep into the meat to pasteurize any fissures or other parts which could have been contaminated after cooking and before packaging. Infrared heating deliveries the heat energy directly to the meat surface through the plastic, but requires the same process of conduction within the meat. Since conduction is a relatively slow process, the time to raise the heat to a pasteurization level at an adequate depth causes a substantial amount of heat to be delivered deeper into the meat product. This heat delivered deeper into the product causes further cooking. To stop the cooking then requires rapid chilling. This introduces additional process steps, complexity and cost to the post package pasteurization of solid meat products.

### SUMMARY OF THE INVENTION

The present invention is a technique for treating packaged solid meat products by applying microwave energy at an elevated operating frequency such as 2450 MHz. The microwave energy is provided at a relatively low power level, such as 1 kilowatt (kW) per pound per minute. This frequency is sufficiently high such that energy penetration depth is limited, and thus it only causes rapid heating of the outer surface of the product. The result is thus much like searing in which the meat product is only heated to a minimum depth. Any juices trapped in the package are also heated rapidly, and spread to fill irregularities in the surface of the product. Because the exterior surface of the meat is heated only to a minimum depth, the interior of the meat product retains its desired doneness, color and texture. Only minimal cooling efforts need to be taken afterwards.

In a preferred embodiment, the microwave energy is applied to the products in a continuous feed type oven. The oven is fed at the top and bottom of a cavity by a circularly polarized microwave feed.

The continuous feed microwave oven may use one or more type of suppression tunnels to prevent the escape of microwave energy from the oven cavity. The suppression tunnel(s) can be water cooled to not only assist with further prevention of radiation leakage but also to provide for cooling of the meat products immediately after their exit from the cavity.

The preapplication of savory coatings in the package may change the loss characteristic and may have an impact on the amount of microwave energy that is desirable to apply.

It should also be understood that multiple cavities can be cascaded and/or fed in parallel to increase the throughput.

In further aspects of the invention, a temperature monitor such as one or more infrared detectors can be used to measure the temperature of the meat product. Such detectors can be placed in multiple locations as the product is conveyed to and/or through the cavity. Temperature information is then fed back to a controller. The controller can then stop the application of the pasteurizing microwave energy when predetermined temperature profiles for the product is reached. For example, it is generally known that listeria can be effectively killed upon elevation to temperatures in a range from about 160 to 180°. Thus, such temperature sensors can be programmed to shut down the microwave applicator if an instantaneous predetermined peak temperature is measured and/or if a certain predetermined temperature exists for more than a predetermined time period such as a few seconds.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIGS. 1A, 1B, 1C and 1D are isometric, top, front, and side views of a packaged meat pasteurization system constructed and operating in accordance with the invention.

FIG. 2 is a view of a water bath supression tunnel.

### DETAILED DESCRIPTION OF THE INVENTION

A description of preferred embodiments of the invention follows.

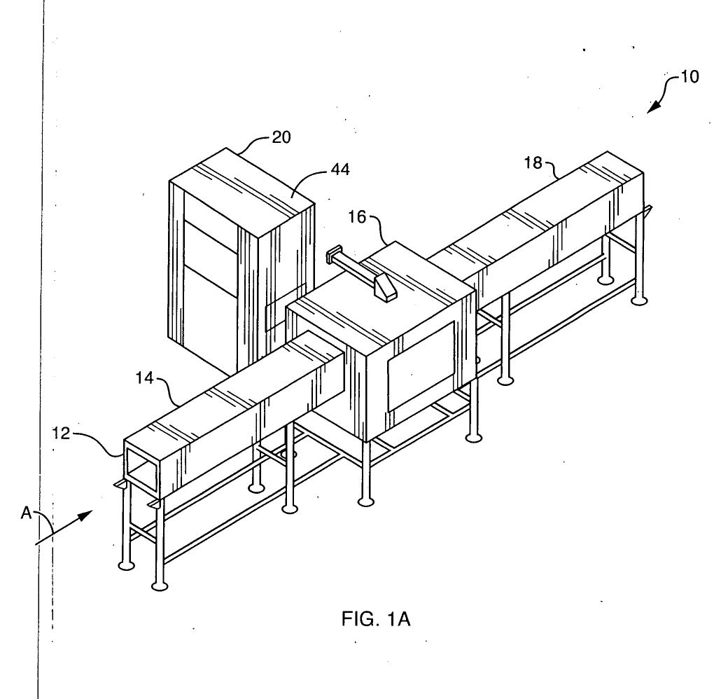

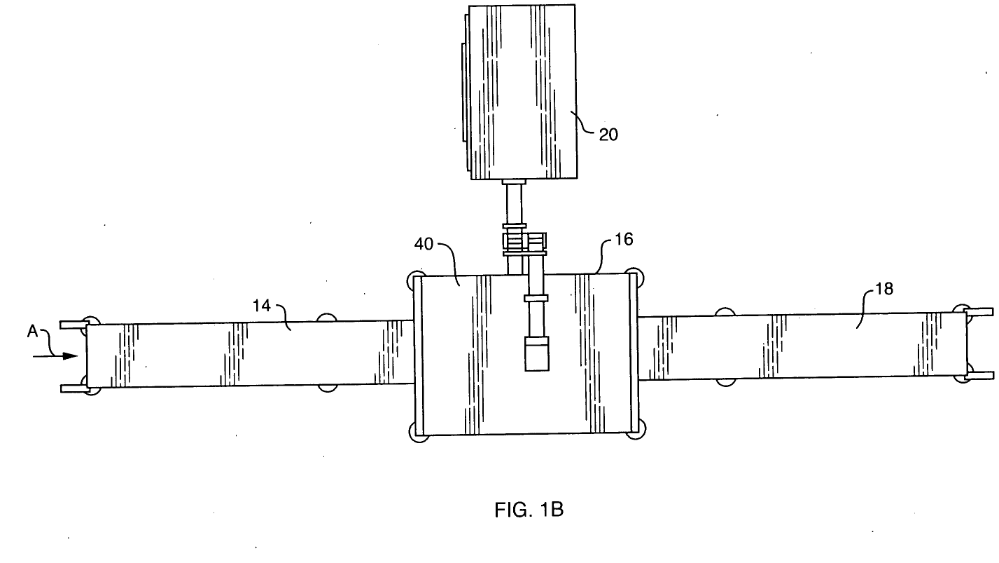

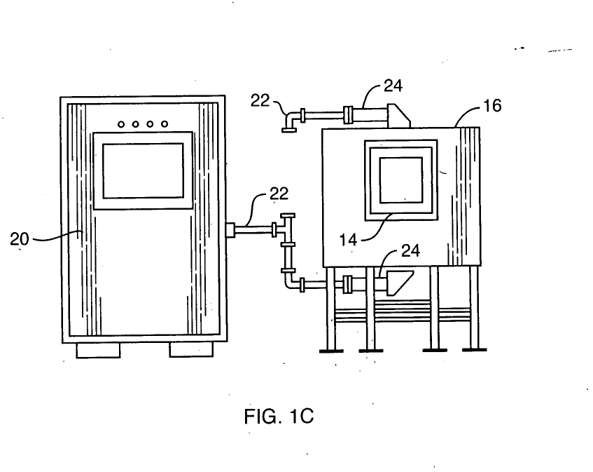

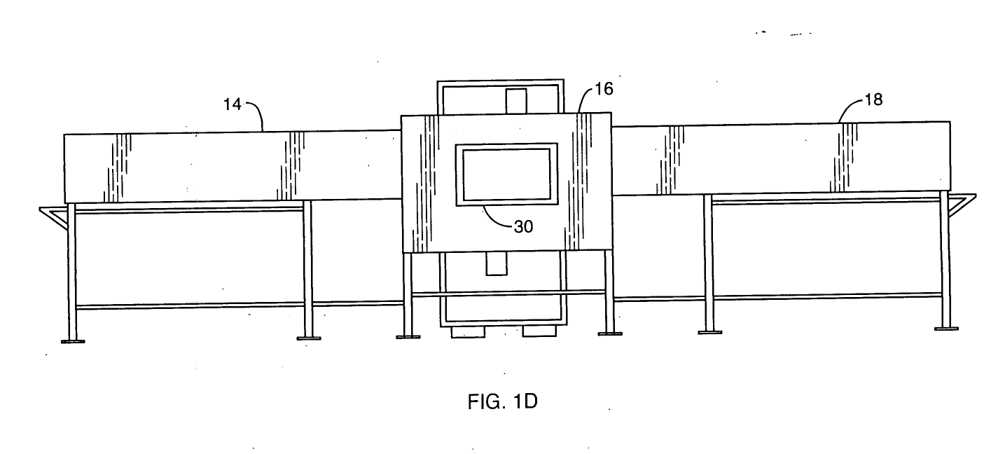

FIGS. 1A, 1B, 1C and 1D show respective isometric, top, front and side views of a continuous feed packaged meat pasteurization system according to the present invention. A packaged solid meat product such as roast beef, turkey, chicken, or deli meat that has not been sliced such as salami, bologna or the like, enter a continuous feed type oven 10 in the direction of arrow A on conveyor 12. The packaged meat product is typically a solid muscle product and has already been cooked. It is already packaged in a heat resistant shrink wrap plastic film and/or tray.

It is desirable to maintain the external appearance texture, color of the meat product such that it is not altered by the pasteurizing process, but at the same time applying a pasteurizing process to remove bacteria such as listeria.

The packaged products travel on conveyor 12 through entrance suppression tunnel 14 to cavity 16 and through exit suppression tunnel 18. The entrance suppression tunnel 12, cavity 16 and exit suppression tunnel 18 are generally constructed as in known in the art. For example the suppression tunnels 14, 18 are formed of metallic exterior metal such as stainless steel and have an interior hollow wall made from material such as propylene and filled with water or propylene glycol solution to suppress the exit of microwaves from cavity 16. Cavity 16, also formed of stainless steel receives microwave energy from power source 20.

Microwave power source 20 provides an operating power at a radiation frequency of 2450 mHz. Microwave energy is carried through suitable waveguides 22 and power feeds 24. The waveguides 22 can be any standard convenient waveguide size. The waveguide 22 and polarized feeds 24 are preferably circularly polarized microwave feeds such as described in U.S. Pat. Nos. 6,034,362 and 6,274,858 assigned to Ferrite Company, the assignee of the present invention.

Feeds 24 are located at the top and bottom of the cavity 16 respectively and are preferably offset such that their application of energy provides for uniform mixing of microwave energy within cavity 16. The offset, for example, may be 6 inches along the longitudinal axis that is the direction of travel of arrow A.

The oven cavity 16 may have a dimension of approximately 46 inches deep by 40 inches high by 60 inches long. A door 30 may be placed on the side of cavity 16 to allow access for cleaning of the interior of cavity 16.

One or more temperature sensors 40 are placed in the cavity 16 so that temperature signals can be fed back to a controller contained in power source 20 to be used in a manner described below.

The suppression tunnels 14, 18 may be approximately 96 inches in length with an insert opening of 12 by 12 inches that is or other dimension large enough to accommodate the expected meat products.

In accordance with a preferred embodiment packaged meat products enter the entrance tunnel 14 in the direction of arrow A, and travel along conveyor 12 entering cavity 16. While in cavity 16 the packaged meat products are exposed to microwave energy at 2450 MHz for pasteurization at a controlled power of level of approximately 1 KW per pound per minute. For example, a roast beef of approximately 7 pounds will have an applied power level of about 7 KW for a total duration of 1 minute. The exact duration and amount of power may be adjusted based on whether or not the meat has been coated with savory sauce, and can also change according to an expected surface area of a particular meat product.

According to other aspects of the invention, it has been found that the application of this power level and indicated duration is sufficiently such that it avoid further unnecessary cooking of the interior muscle meat product. The process is like searing, in that the outer surface is heated very rapidly. It has also been found that juices packaged within the meat package will also heat, rapidly spreading out within the package and filling any irregularities in the external meat surface.

In accordance with further aspects of the invention, one or more temperature sensors 40 provide the ability to monitor the pasteurization process. The sensor(s) 40 which may be infrared sensors, measure the temperature of meat products as they progress through the cavity 16. The temperature measurement is then used to control the pasteurization process. For example, in order to destroy listeria it is known to be necessary to achieve a temperature of from at least about 160° to about 180° F. Thus the temperature sensor 40 output may be fed back to a programmable basic controller (PLC) 44 associated with the power source 20. The PLC 44 may be set to shut off the microwave energy source 20 when a predetermined temperature is reached and/or when a predetermined temperature has been seen for a predetermined period of time.

For example, upon measuring an instantaneous temperature of 212°, the PLC 44 may shut off the power source 20 to that particular food product. Similarly, if exposure to a predetermined temperature such as 200° for a time duration such as greater than 3 seconds is measured, then the power source 20 may be shut off.

It is possible that multiple temperature sensors 40 can be placed along the interior of the cavity to monitor the progress of the packaged meat product as it passes through the conveyor, and program the PLC to predict heating profiles.

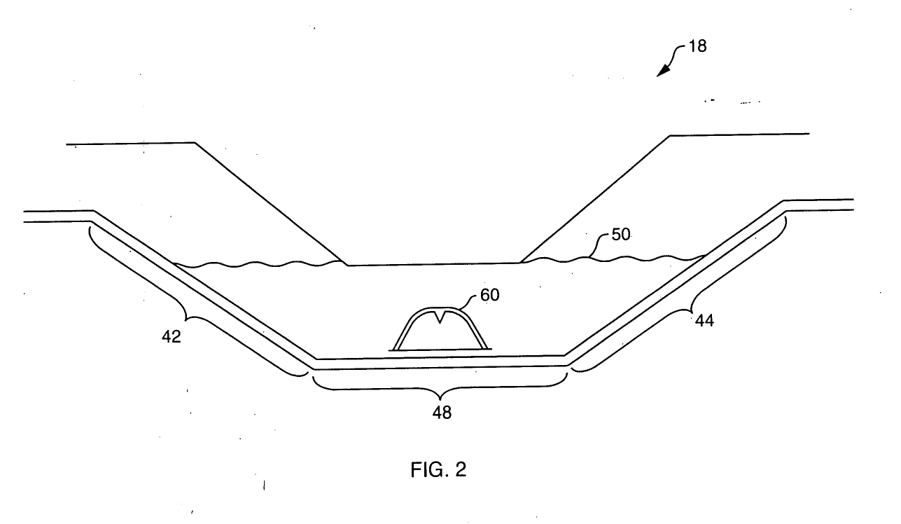

In accordance with alternative aspects of the invention, the entrance 14 and especially exit suppression tunnel 18 may be arranged to provide for water cooling. In this arrangement such as shown in FIG. 2, the suppression tunnel 18 has at least one upper section 47, a lower section 48, and a second upper section 49. The packaged meat product 60, after being pasteurized and exiting from cavity 16, travels along conveyor 12 through at least one area such that it becomes completely submersed in water 50 or other fluid. The water 50 not only provides for cooling of the packaged meat product 60, but also prevents further radiation leakage from suppression tunnel 18. In this embodiment the suppression tunnel 18 may need not be the full 96 inches as previously mentioned, but may have a much shorter overall length dimension allowing the system 10 to be placed in a much more confined space than would otherwise be possible.

While this invention has been particularly shown and described with references to preferred embodiments thereof, it will be understood by those skilled in the art that various changes in form and details may be made therein without departing from the scope of the invention encompassed by the appended claims.

What is claimed is:

1. A system for pasteurization of a packaged solid meat product comprising:
a microwave energy applicator for applying microwave energy at a frequency of at least 2400 mHz to the packaged meat product.
